(19) United States
(12) Patent Application Publication
(10) Pub. No.: US 2020/0405030 A1
(43) Pub. Date: Dec. 31, 2020

(54) FLEXIBLE HEATING DEVICE

(71) Applicant: L'OREAL, Paris (FR)

(72) Inventors: Gaurav AGARWAL, Kanagawa (JP); Chin Kai LEE, Kanagawa (JP)

(21) Appl. No.: 16/976,240

(22) PCT Filed: Feb. 27, 2019
(86) PCT No.: PCT/JP2019/008977

§ 371 Date: Aug. 27, 2020

(30) Foreign Application Priority Data
Mar. 1, 2018 (JP) 2018-036343

(51) Int. Cl. A45D 2/36; A45D 7/06; H05B 1/02; H05B 3/36; H05B 3/34

(52) U.S. Cl. CPC A45D 2/367; A45D 7/06; H05B 3/342; H05B 3/36; H05B 1/0252

(57) ABSTRACT

A flexible heating device for hair shaping is disclosed. The flexible heating device in the form of a sheet, for hair shaping, comprises a heating layer comprising at least one flexible heater which can be supplied with electrical power, a flexible heat conductive layer provided on one surface of the heating layer, and a flexible heat insulation layer provided on the other surface of the heating layer, wherein the device is capable of forming an occlusive or closed space around the hair.

### TECHNICAL FIELD

The present invention relates to a flexible heating device for hair shaping and more specifically, a flexible heating device for hair shaping by applying heat to at least a part of hair placed in an occlusive or closed space. The present invention also relates to a hair shaping system comprising said flexible device for hair shaping. The present invention further relates to a method of shaping hair, in particular, a method of shaping hair using said hair shaping system.

### BACKGROUND ART

Hair shape modifications which include straightening of hair, curling of hair, adding volume, and the like are popular. The modifications can be achieved with compositions such as hair styling gels, creams or hair lacquers. These products enable the shaping of the hair but are removed with shampoo and thus must be applied on a daily basis.

The most general technique for obtaining long-lasting shape modification of the hair consists, in a first step, of opening the keratin S—S disulfide bonds (cystine) in the hair with a composition comprising a suitable reducing agent (reducing step) then, once the thus-treated hair has been rinsed, generally with water, reforming said disulfide bonds in a second step, by applying an oxidizing composition onto the hair which has been placed beforehand under tension, using curlers for example (an oxidizing step, also called a fixing step), so as to give the hair the desired form in the end.

The modified shape that is imposed on the hair by means of a chemical treatment, such as explained above, is relatively long-lasting and is particularly resistant to washing operations with water or shampoo, as compared to the usual simple methods for temporarily reshaping the hair by using foams, styling gels, or lacquers.

The long lasting hair shaping step also needs a heating device to attain good efficacy on hair shaping. For example, patent literature WO 2011/155076 discloses a perm process comprising the steps of: applying onto keratin fibers a composition comprising one or several alkaline agents; placing the keratin fibers in an occlusive space; and heating the keratin fibers. Patent literature JP-A-2008-081471 discloses a hair deformation agent which comprises an oily material in an amount of 85-99.9% by weight and an oil-soluble reducing agent. A high temperature hair iron may be used in this application. Moreover, patent literature JP-A-H05-306212 discloses a hair deformation method characterized by applying to the hair a composition containing 20 to 100% by weight of a polyol, and allowing the hair to deform at a temperature of 50 to 250° C.

In addition to heating, an occlusive system also helps to give a better curling effect. Patent literature U.S. Pat. No. 8,517,034 B2 discloses covering tensioning devices rolled with keratin fibers with a cover comprising at least one heat-insulating material so as to form at least one closed space above the keratin fibers.

For heating of the curled hair, digital perm machines are the most common systems, and consist of multiple heating rollers to heat individual strands of hair. Such systems are big in size and can be used only by professionals due to their high cost.

The home use heating roller system has already been developed in the past. For example, patent literature US 2005/0056297 A1 discloses a heat delivery system for heated rollers/curlers and clips. This system consists of a housing on which each heated roller is mounted on a rail to heat up the roll and then a heated roller is attached to the hair. In such a system the heating cannot be consistent or constant during application as the rollers cool down gradually.

### DISCLOSURE OF INVENTION

Overall, the existing heating systems for hair shaping are not flexible enough to adopt for shaping of the hair, and therefore, hair that has been rolled, for example, cannot receive consistent or constant heating in occlusive systems.

It is an objective of the present invention to provide a device, a system, and a method, each of which enables to easily form a closed or occlusive space for the hair to be shaped or reshaped and can provide the hair with consistent and constant heating in the closed or occlusive space.

In order to attain the above objective, the present invention proposes a flexible heating device in the form of a sheet, for hair shaping, comprising a heating layer comprising at least one flexible heater which can be supplied with electrical power, a flexible heat conductive layer provided on one surface of the heating layer, and a flexible heat insulation layer provided on the other surface of the heating layer, wherein the device is capable of forming an occlusive or closed space around the hair.

In a preferred embodiment, the flexible heater may comprises at least one textile heater.

In another preferred embodiment, the flexible heat conductive layer may comprises a least one metal film. It is more preferable if the metal film comprises aluminum foil.

In another preferred embodiment, the flexible heat insulation layer may comprises any of fiber glass, polyurethane foam, and mineral wool, and combinations thereof.

According to another aspect of the present invention, the flexible heating device for hair shaping comprises at least one fixing means for fixing the flexible heating device on the hair.

In one embodiment, the fixing means may comprise at least one tape-shaped fastener or at least one elastic ring.

According another aspect of the present invention, a hair shaping system is provided. The hair shaping system comprises the above-mentioned flexible heating device for hair shaping according to one aspect of the present invention, a power supply, and electric lead wires which extend from the flexible heater(s) of the flexible heating device(s) for hair shaping to the power supply.

According to yet another aspect of the present invention, a method of shaping is provided. The method of shaping hair comprises the step of:

a) forming at least one occlusive or closed space around hair to be shaped with a flexible heating device in the form of a sheet comprising a heating layer comprising at least one flexible heater which can be supplied with electrical power, a flexible heat conductive layer provided on one surface of the heating layer, and a flexible heat insulation layer provided on the other surface of the heating layer, and
b) heating the hair with the flexible heating device by applying electric power to the flexible heater.

Preferably, the method comprises, before the step a), the step of providing hair with mechanical tension.

Preferably, the method comprises, after the step a), the step of fixing the flexible heating device on the hair by at least one fixing means to maintain the occlusive or closed space.

In a preferred embodiment of the method, the fixing means may comprise at least one tape-shaped fastener or at least one elastic ring.

Preferably, the occlusive or closed space may comprise a means for providing the hair with mechanical tension.

In a further preferred embodiment, the method further comprises, before or after the step a), the step of applying at least one composition, preferably a composition with a pH of more than 7, and more preferably a composition with a pH of more than 7 including at least one organic or inorganic alkaline agent to the hair.

Preferably, in step b) of the method, the heating is performed at a temperature between 30° C. and 200° C., preferably between 50° C. and 180° C., and more preferably between 70 and 150° C.

More preferably, in step b), the heating is performed between 5 and 100 minutes, preferably 10 to 60 minutes, and more preferably 15 to 30 minutes.

According to the present invention, it can be easy to place hair to be shaped in a closed or occlusive space and to heat the hair to be shaped at an adequate temperature and maintain consistent and constant heating of the hair.

### BRIEF DESCRIPTION OF DRAWINGS

FIG. 1 shows a schematic sectional view of the flexible heating device for hair shaping according to one embodiment of the present invention.

FIG. 2 shows an example of a flexible heater, that is, a textile heater.

FIG. 3 shows an example of a conductive yarn which constitutes the textile heater shown in FIG. 2.

FIG. 4 shows one embodiment of a hair shaping system comprising the flexible heating device for hair shaping shown in FIG. 1. In this figure, the flexible heating device comprises a tape-shaped fastener as a fixing means.

FIG. 5 shows a perspective view of the flexible heating device for hair shaping according to one embodiment of the present invention together with a tape-shaped fastener.

FIG. 6 shows an example of the usage of the hair shaping system according to one embodiment of the present invention in which the flexible heating device is used with a curler.

FIG. 7 shows a graph presenting the relationship between time and temperature of the flexible heating device for several cases in which the voltage of a power source is different as well as the same relationship for the case of a conventional digital perm machine.

FIGS. 8A to 8C are pictures which show the effect of the hair shaping system according to the present invention.

FIG. 9 shows a modified embodiment of the hair shaping system according to the present invention

FIG. 10 shows a schematic sectional view of the flexible heating device for hair shaping according to a second embodiment which has an elastic ring as a fixing means.

FIG. 11 shows a perspective view of the flexible heating device for hair shaping shown in FIG. 10 in more realistic way.

FIG. 12 shows a schematic view of a hair shaping system comprising the flexible heating device for hair shaping according to a second embodiment of the present invention.

FIG. 13 shows a usage state of the flexible heating device for hair shaping according to the second embodiment of the present invention.

FIG. 14 shows a graph presenting the relationship between time and temperature of the flexible heating devices according to the first and second embodiments of the present invention.

FIG. 15 shows a plan view of a hair shaping system according to a third embodiment of the present invention, this embodiment being for straight perm or curly hair straightening.

FIG. 16 shows an example of the usage of the hair shaping system according to third embodiment of the present invention shown in FIG. 15.

FIG. 17 shows the hair shaping system according to third embodiment of the present invention in a usage state shown in FIG. 16 without showing the hair.

### BEST NODE FOR CARRYING OUT THE INVENTION

Hereinafter, the present invention will be described in more detail with reference to the accompanying drawings. In the drawings, the same reference numerals as those shown in the other drawings denote the same elements.

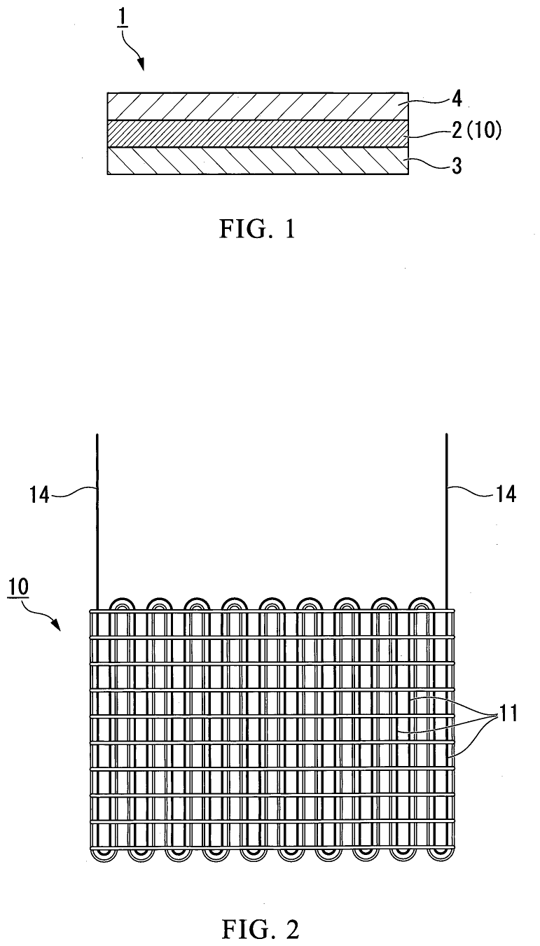

FIG. 1 shows a schematic sectional view of a flexible heating device 1 for hair shaping according to an embodiment of the present invention. The device 1 has a sheet-like shape in general and has a layered structure comprising three layers, that is, a heating layer 2 constituted by a flexible heater which can be supplied with electrical power, a flexible heat conductive layer 3 provided on one surface of the heating layer 2, and a flexible heat insulation layer 4 provided on the other surface of the heating layer 2. The device 1 is capable of forming an occlusive or closed space around the hair as explained later.

The heating layer 2 shown in FIG. 1 is constituted by a flexible heater, and in this embodiment, the flexible heater is composed of a textile heater 10, an example of which is shown in FIG. 2. The textile heater 10 can be constituted as a textile or woven fabric of conductive yarn 11. Here, conductive yarn means a yarn having electrical resistance and able to produce heat when electricity is conducted through the conductive yarn.

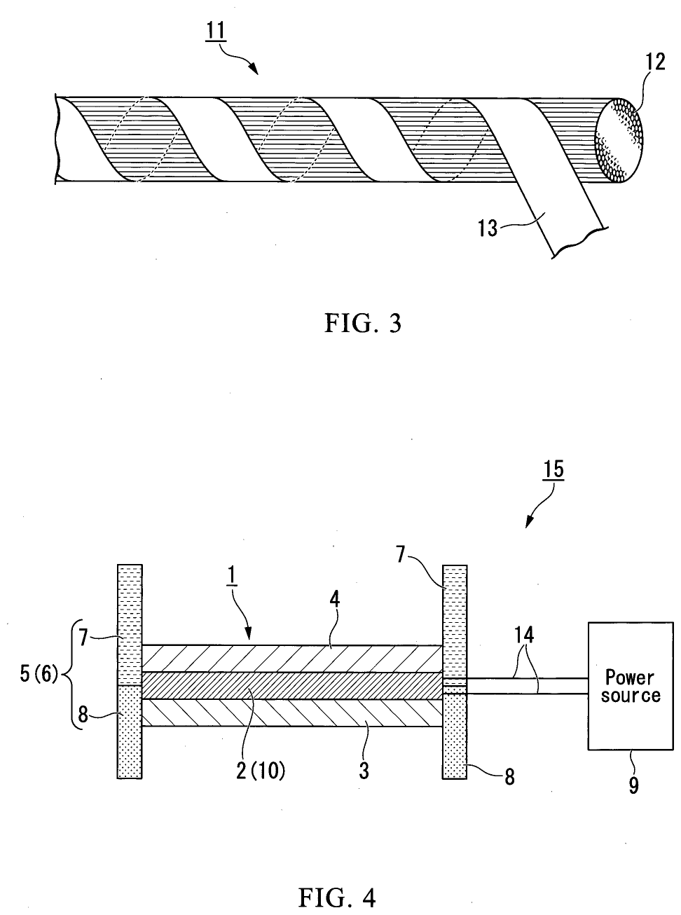

In this embodiment, the textile heater 10 can be constituted by a textile woven by conductive yarn 11 shown in FIG. 3. This conductive yarn 11 is made up, for example, of a plurality of strands of polymer yarn 12 which form a core thereof and a micro metal foil strip 13 which covers at least a part of the polymer yarn 12. Polymer yarn 12 may be made of polyamide, polyester, polypropylene, or other synthetic fibers, and diameter of which may be between 10 μm and 30 μm. The diameter of the conductive yarn 11 in total may be 0.27 mm to 0.50 mm. As a result, the basis weight of the textile heater 10 may be between 30 g/m² and 100 g/m². Such a conductive yarn 11 can be woven or knitted to make a flexible heater structure. For example woven flexible heater structure is available from Litex, Taiwan.

Some other examples of commercially available textile based heating fabrics are Seafar Power Sheet available from Seafar and Tibgrid® available from Tibtech, for example. Furthermore, another kind of sheet-like heater having a woven structure is disclosed for example in JP-A-2004-33730. A net shaped heater made by tricoat knitting is disclosed in JP-A-2001-110555. Similarly, U.S. patent publication No. US 2014/0374404 A1 discloses a flexible heater by an interlocked knitting structure. These materials can also be used as the flexible heater of the flexible heating device 1 for hair shaping according to the present invention. It may be preferable that, the flexible heater be made as a textile by well-known weaving or knitting process, not a non-woven fabric.

As shown in FIG. 2, two electric lead wires 14 can extend from the textile heater 10 for receiving a supply of power.

The flexible heat conductive layer 3 may be formed by materials which have good thermal conductivity and flexibility. Furthermore, the heat conductive layer 3 may be required to be impermeable, especially to water, since this layer 3 is intended to form a closed or occlusive space as explained hereinafter. A metal film may be a preferred material for forming the layer 3. It may be more preferable if the material has a chemical resistance to certain chemical agents since this heat conductive layer 3 possibly contacts some chemical agents applied to the hair as described below. From this point of view as well as due to its cost effectiveness and easy availability, aluminum foil may be the most preferable material in this case for forming the flexible heat conductive layer 3.

The flexible heat insulation layer 4 may be formed by materials which have a good heat insulation property and flexibility. Therefore, the heat insulation layer 4 may be formed by a sheet of fiber glass, polyurethane foam, mineral wool, and combination thereof.

The above-explained three layers, that is, the heating layer 2 (textile heater 10), the flexible heat conductive layer 3, and the flexible heat insulation layer 4 may be bonded with an adhesive having heat resistance. However, other bonding means are also possible, such as sewing these three layers.

In this embodiment, the flexible heating device 1 for hair shaping may generally have a rectangular shape with a size of 8×5 cm for example. This size may be preferable for the device 1 to be used with an ordinary hair curler of usual size. However, the size of the device 1 is not limited to this extent.

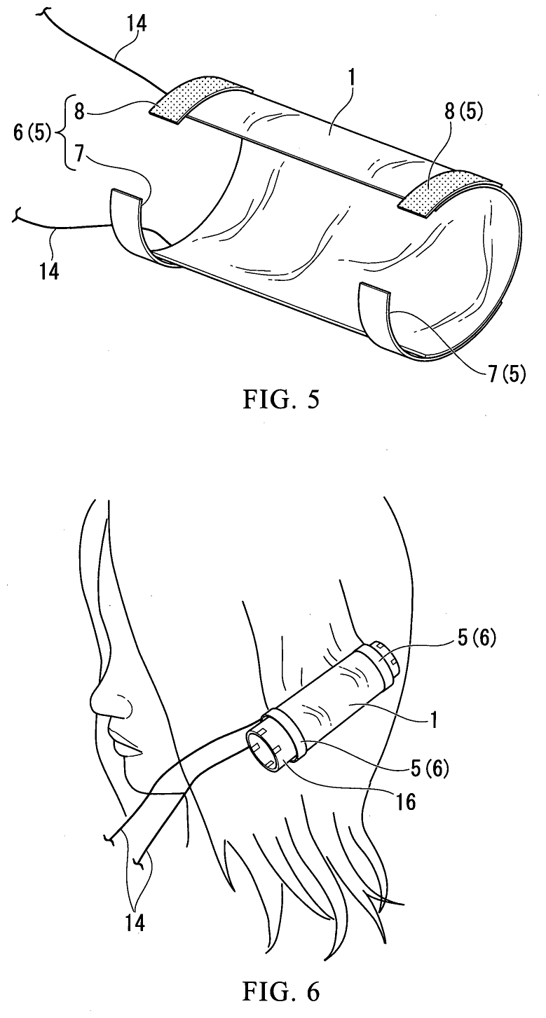

The flexible heating device 1 for hair shaping may be provided with a fixing means 5, as shown in FIGS. 4 and 5, to attach the device 1 on hair. It should be noted here that FIG. 4 is depicted very schematically. In this embodiment, the fixing means 5 is constituted by a tape-shaped fastener 6, or Velcro®. As shown in FIGS. 4 and 5, the tape-shaped fastener 6 is provided along both side edges of the flexible heating device 1. Either end of the tape-shaped fastener 6 extends beyond the edge of the device 1. On one surface of the one end region of the tape-shaped fastener 6, a plurality of hooks 7 are formed, and on the opposite surface of the other end region of the tape-shaped fastener 6, a plurality of loops 8 are formed. When both end regions are overlapped and pressed, the hooks 7 on one end region can engage with the loops 8 on the other end region and thus both end regions of the tape-shaped fastener 6 can be connected.

As shown in FIG. 4 and also as explained above referring to FIG. 2, two electric lead wires 14 extend form the textile heater 10 of the device 1 for receiving a supply of power. The opposite ends of the electric lead wires 14 connect to a power source 9. The power source 9 is controllable in terms of feed voltage and feed time to control the temperature of the textile heater 10. The origin of the power supply for the power source 9 may be a household power supply, business power supply, charging battery, or dry battery.

The above-explained flexible heating device 1 for hair shaping with the fixing means 5 (tape-shaped fastener 6), the power source 9, and the electric lead wires 14 constitutes an example of a hair shaping system 15 which is another aspect of the present invention.

Next, an exemplary method of shaping hair using the above-mentioned hair shaping system 15 will be described hereinafter.

In an exemplary method of shaping hair using the hair shaping system 15, first, mechanical tension can be applied to a portion of hair to be shaped. This mechanical tensioning step can be achieved by, for example, rolling up the portion of the hair to be shaped with a mechanical tensioning means, such as a curler. As the mechanical tensioning means, a curler is common, but other means such as a roller, a clip, or the like, can also be used.

In the next step, the hair may get wet by means of a dampening agent. As the dampening agent, although water may possibly be used, a composition including at least one chemical agent is more preferable to achieve a better reshaping effect. The composition may have a pH of more than 7, and more preferably, the composition may have a pH of more than 7 and include at least one organic or inorganic alkaline agent. The composition may also include at least one reducing agent.

After some time (for example 15 minutes), the portion of the hair which may be rolled up by a curler and to which the dampening agent may be applied can be covered with the above-explained flexible heating device 1 for hair shaping. Here, the device 1 can cover the portion of the hair together with the curler 16 as shown in FIG. 6, thus forming a closed space inside the rounded or rolled device 1. In FIG. 6, the power source 9 constituting the hair shaping system 15 is not depicted.

When the flexible heating device for hair shaping is placed on hair to be shaped, the device can form a closed space in which heat can be maintained therein, but heat cannot diffuse out or is difficult to diffuse out of the closed space. The closed space may also be called an “occlusive space”.

In the next step, electric power can be supplied to the textile heater 10 of the device 1 from the power source 9 via the electric lead wires 14 to heat the textile heater 10. Here, the heating can be performed at a temperature between 30° C. and 200° C., preferably between 50° C. and 180° C., and more preferably between 70 and 150° C. Furthermore, the heating can be performed between 5 and 100 minutes, preferably 10 to 60 minutes, and more preferably 15 to 30 minutes.

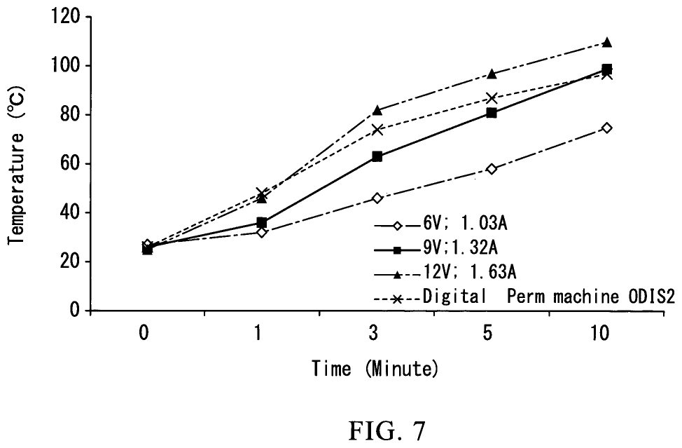

FIG. 7 shows a graph presenting the relationship between time and temperature of the textile heater 10 for each case in which the voltage of the power source 9 is different. The same relationship for existing Digital Perm. Machine, OOHIRO ODIS-2, is also presented on the graph for reference. As can be seen in the graph, 9V is most efficient as the power source 9 for the device 1 according to this embodiment for heating the textile heater 10 up to around 100° C.

Therefore, in this exemplary method, the voltage applied to the textile heater 10 may be set at 9V (1.32 A). Though, the most preferable heating time may be 15 to 30 minutes as mentioned above, the time during which the supply of electric power to the textile heater 10 continues may be set about 10 minutes for this experimental embodiment.

In the next step, the power source 9 may be turned off and the hair can be cooled down for, for example, 5 minutes.

After that, the device 1 may be removed from the hair and the curler 16.

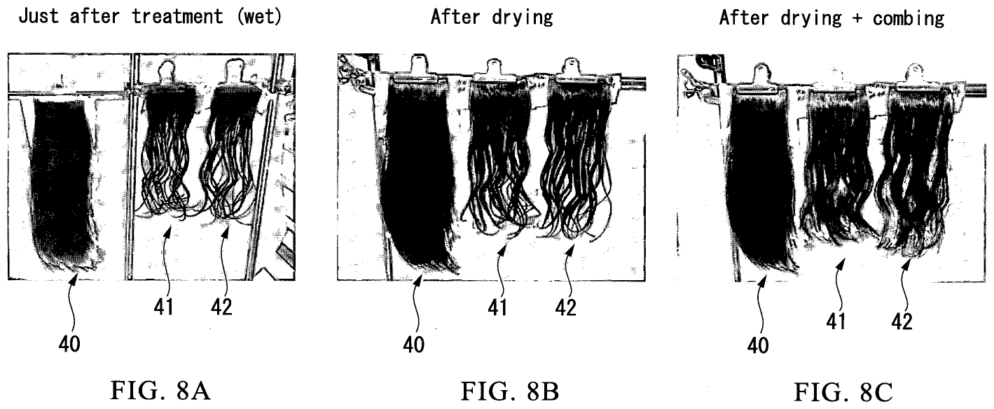

FIG. 8A shows three swatches of hair. The left one is an untreated hair swatch 40 of 20 cm length. Located in the middle in FIG. 8A is a treated hair swatch 41 which originally had the same constitution as the untreated hair swatch 40 shown on the left in FIG. 8A and the treated hair swatch 41 was subjected to the treatment explained above, using the hair shaping system 15 comprising the flexible heating device 1 for hair shaping. In FIG. 8A, the treated hair swatch 41 had not been dried yet and was wet. As can be seen in FIG. 8A, the treated hair swatch 41 was clearly curled due to the above-mentioned process. The right one in FIG. 8A is also a treated hair swatch 42 and this treated swatch 42 will be explained later in conjunction with another embodiment of the method of the present invention.

Each of FIG. 8B and FIG. 8C also shows three hair swatches similar to those mentioned above, but treated hair swatch 41 was subjected to additional treatments. That is, in FIG. 8B, treated hair swatch 41 was dried by a dryer. In FIG. 8C, treated hair swatch 41 was combed during drying. As shown in FIGS. 8B and 8C, it can be observed that treated hair swatch 41 was sufficiently shaped after drying and even after combing.

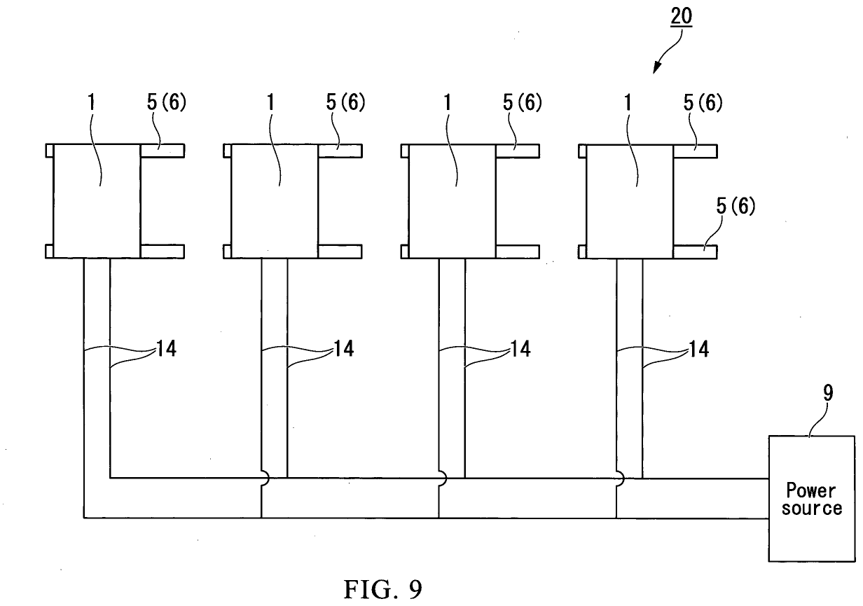

FIG. 9 schematically shows a hair shaping system 20 which is another embodiment of the hair shaping system according to the present invention. The hair shaping system 20 is similar to the hair shaping system 15 depicted in FIG. 4, but it has a plurality of devices 1,1,1,1. Each flexible heating device 1 for hair shaping is the same as or similar to that shown in FIGS. 4 and 5 and these devices 1,1,1,1 are connected to a power source 9 in parallel via electric lead wires 14.

Due to the hair shaping system 20, multiple portions of the hair can be reshaped at the same time.

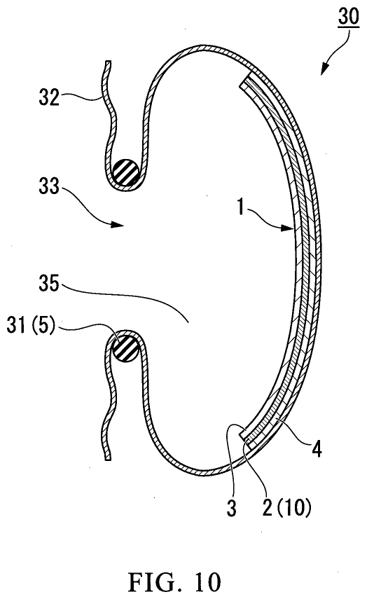

Next, FIGS. 10 to 12 show a hair shaping system 30 which is another embodiment of the hair shaping system according to the present invention.

In the hair shaping system 30, the flexible heating device 1 for hair shaping comprises another type of a fixing means 5. That is, in the hair shaping system 10 and in the hair shaping system 15 explained above, the fixing means 5 for the device 1 is composed of the tape-shaped fastener 6 as mentioned above. However, in the hair shaping system 30 according to this embodiment, the fixing means 5 is composed of at least one elastic ring 31 as shown in FIG. 10.

In this embodiment, the flexible heating device 1 is provided generally at the central position of one surface of an elastic sheet 32. The elastic sheet 32 may be made of at least one elastic material which may have characteristics of impermeability for water, heat insulation, and chemical resistance.

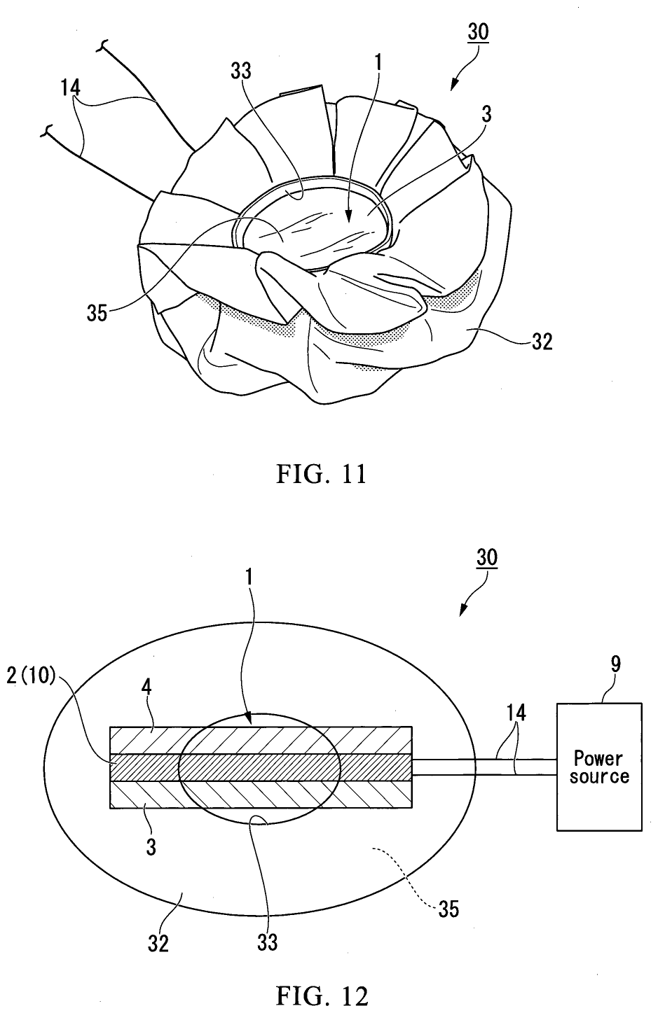

By folding the periphery region of the elastic sheet 32 so as to wrap the device 1 and choking the middle portion of the periphery region by the elastic ring 31, the elastic sheet 32 presents, as a whole, a shape of a cap or cap-shaped structure having an opening 33 as shown in FIGS. 10 and 11. In this embodiment, the heat insulation layer 4 of the device 1 can be bonded to the one surface of elastic sheet 32, and therefore, the heat conductive layer 3 of the device 1 can face the opening 33. The elastic ring 31 may be substituted with a rubber string, elastic band, or the like which can elastically choke a portion of the elastic sheet 32 to form the opening 33.

As shown in FIG. 12, from the textile heater 10 of the device 1, two electric lead wires 14 can extend outside the cap-shaped structure for receiving a supply of power. The opposite ends of the electric lead wires 14 connect to a power source 9 as shown in FIG. 12. The above-explained flexible heating device 1 for hair shaping comprising the fixing means 5 (elastic ring 31), the power source 9, and the electric lead wires 14 constitutes the hair shaping system 30.

Next, an exemplary method of reshaping hair using the above-mentioned hair shaping system 30 will be described hereinafter.

In the exemplary method of shaping hair using the hair shaping system 30, mechanical tension can be first applied to a portion of hair to be shaped. This mechanical tensioning step can be achieved by, for example, rolling up the portion of hair to be shaped with a mechanical tensioning means, such as a curler. Other mechanical tensioning means such as a roller, a clip, or the like, can also be used.

In the next step, the hair may get wet by means of a dampening agent. As the dampening agent, although water may possibly be used, a composition including at least one chemical agent is more preferable to achieve a better reshaping effect. The composition may have a pH of more than 7, and more preferably, the composition may have a pH of more than 7 and include at least one organic or inorganic alkaline agent. The composition may also include at least one reducing agent.

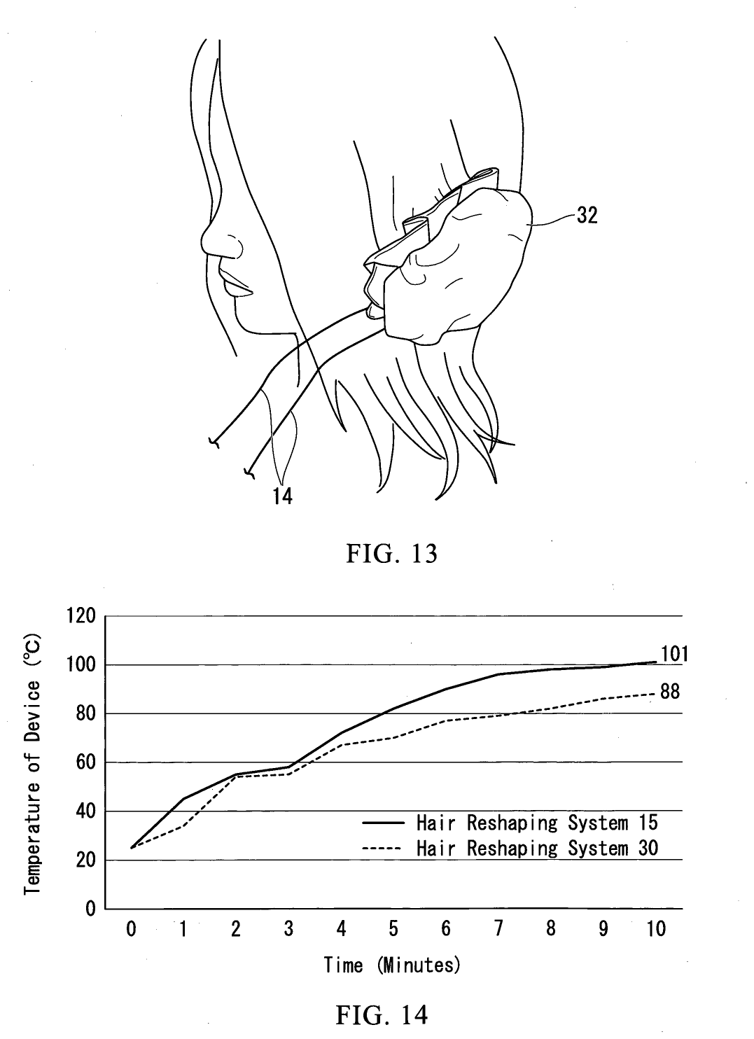

After some time (for example 15 minutes), the portion of the hair which may be rolled up by a curler and to which the dampening agent may be applied can be covered with the cap-shaped structure, as shown in FIG. 13, which comprises inside the flexible heating device 1 for hair shaping. In FIG. 13, only the cap-shaped structure and the electric lead wires 14 are depicted for the hair shaping system 30 and the power source 9 is omitted. The cap-shaped structure, i.e., flexible heating device 1, is thus fixed to the hair by the elastic ring 31.

In this embodiment, the portion of the hair which may be rolled up and to which the dampening agent may be applied can completely be accommodated in the inner space 35 (FIG. 10) of the cap-shaped structure. Here, since the opening 33 of the cap-shaped structure can be covered with the hair due to the choking effect by the elastic ring 31, the portion of the hair which may be rolled up and to which the dampening agent may be applied can be set in a closed or occlusive space.

In the next step, electric power can be supplied to the flexible heater 10 of the device 1 inside the cap-shaped structure from the power source 9 via the electric lead wires 14 to heat the textile heater 10. In this exemplary method, the voltage applied to the flexible heater 10 may be set at 9V (1.32 A) and the time during which the supply of electric power to the textile heater 10 continues may be about 10 minutes. Again, though the most preferable heating time may be 15 to 30 minutes, the time during which the supply of electric power to the textile heater 10 continues may be set about 10 minutes.

In the next step, the power source 9 may be turned off and the hair can be cooled down for 5 minutes.

After that, the cap-shaped structure having the device 1 can be removed from the hair and the curler, if present, is next removed from the hair.

For evaluating the method of shaping hair according to this embodiment, FIGS. 8A to 8C are referred to again. Located on the right in each figure is a treated hair swatch 42 which originally had the same constitution as the untreated hair swatch 40 shown on the left in each figure. In FIG. 8A, the treated hair swatch 42 was subjected to the treatment explained above, using the hair shaping system 30 explained above. In FIG. 8B, the treated hair swatch 42 was dried by a dryer. In FIG. 8C, the treated hair swatch 42 was combed while drying. In all embodiments, the treated hair swatch 42 was clearly curled.

It can be seen, especially in FIG. 8c, that the length of the treated hair swatch 41 was shorter than that of the treated hair swatch 42. This indicates that the shaping or curling effect remained stronger in the hair swatch 41 treated by the process using the hair shaping system 15 than the hair swatch 42 treated by the process using the hair shaping system 30. It is conceivable that the reason for this may be that in the hair shaping system 15, since the device 1 wraps around the portion of hair to be shaped, heat produced by the device 1 is directly or effectively transferred to the whole area of the hair. Also, another reason for this may be that in the hair shaping system 15, the closed or occlusive space formed by the hair shaping system 15 is more restricted or narrower than that formed by the hair shaping system 30, and therefore the heat can be applied to the portion of hair more consistently or more constantly.

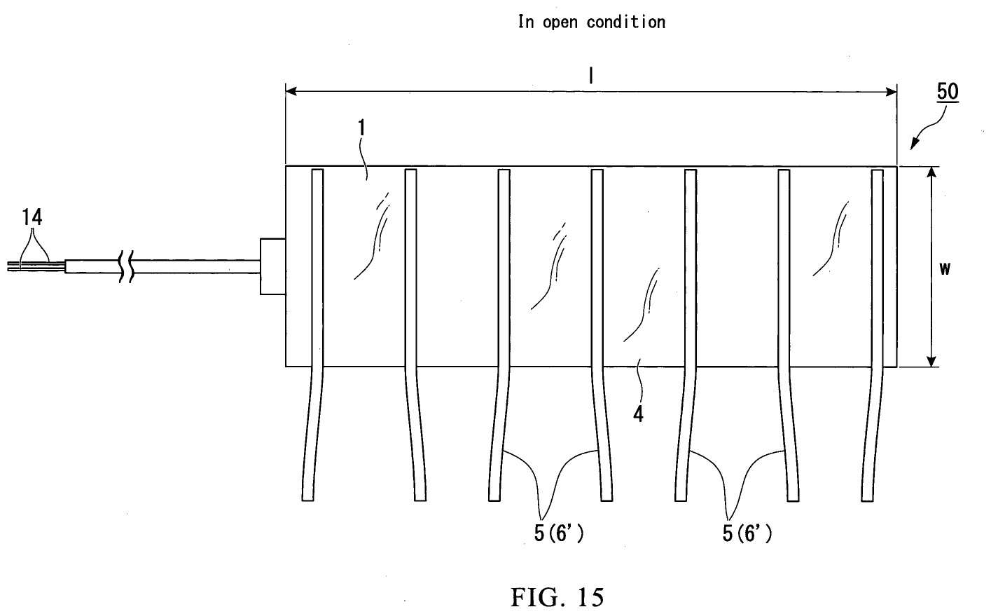

FIG. 14 shows a graph presenting the relationship between time and temperature of the flexible heating device for hair shaping 1 for each of the hair shaping system 15 and the hair shaping system 30. The voltage of the power source 9 was set at 9V in both cases. The graph shows that in 10 minutes the hair shaping system 15 was able to achieve a higher temperature than the hair shaping system 30. This result also indicates that the closed or occlusive space formed by the hair shaping system 15 was more restricted or narrower than that formed by the hair shaping system 30.

However, it can be observed from FIG. 8C for example that treatment by the process using the hair shaping system 30 is also sufficiently effective. Although the hair shaping system 15 may be more effective than the hair shaping system 30 when compared under the same conditions as indicated above, the hair shaping system 30 can have an advantage in which it can be set to hair more easily than the hair shaping system 15. Therefore, if the conditions, such as voltage of the power source 9, heating time, size of the device 1, etc., are changed for hair shaping system 30, the same result as that of the hair shaping system 15 may be achieved.

Furthermore, in the hair shaping system 30, according to the embodiment explained, using the elastic ring 31 as a fixing means 5, the flexible heating device 1 is the same as that in the hair shaping system 10 even in its size. However, in the hair shaping system 30, the shape and size of the flexible heating device 1 may differ from those of the hair shaping system 15 because in the hair shaping system 30, the shape and size of the flexible heating device 1 are not limited by those of the mechanical tensioning means such as a curler.

In the embodiments described above, only the embodiment of curling straight hair is described. However, the present invention can also be applied to a so-called straight perm or curly hair straightening in which curled hair can be made straight.

FIG. 15 shows another embodiment of the hair shaping system 50 for performing such a straight perm or curly hair straightening. In the FIG. 15, power source is omitted from the hair shaping system. This hair shaping system 50 is similar to the hair shaping system 15 depicted in FIG. 4 and FIG. 5, but the dimension of the flexible heating device 1 of the hair shaping system 50 is substantially different from and larger than the flexible heating device 1 of the hair shaping system 15. Specifically, in this embodiment, the flexible heating device 1 of the hair shaping system 50 may have 60 cm of length 1 and 20 cm of width w. A plurality of fixing means 5 is provided on one surface of the flexible heating device 1. More precisely, seven tape-shaped fasteners 6′ are arranged on the heating insulation layer 4 which is the outer layer of the flexible heating device 1 across the width w at equal intervals in parallel.

Two electric lead wires 14 can extend from the textile heater (not visible in FIG. 15) of the flexible heating device 1 for receiving a supply of power.

Next, an exemplary method of reshaping hair using the above-mentioned hair shaping system 50 will be described hereinafter.

First, a composition including at least one chemical agent for softening the hair may be applied to a portion of the hair to be treated. The composition used may have a pH of more than 7, and more preferably, the composition may have a pH of more than 7 and include at least one organic or inorganic alkaline agent. The composition may also include at least one reducing agent.

Since the hair shaping system 50 is used for performing straight perm or curly hair straightening as described above, the portion of hair to be treated using the hair shaping system 50 would be curled or wavy.

After the composition is applied to the portion of the hair to be treated, the portion to which the composition may be applied can be combed to make the portion of the hair straight. No mechanical tensioning means is used in this exemplary method. However, a mechanical tensioning means for straightening the hair can also be used in another method.

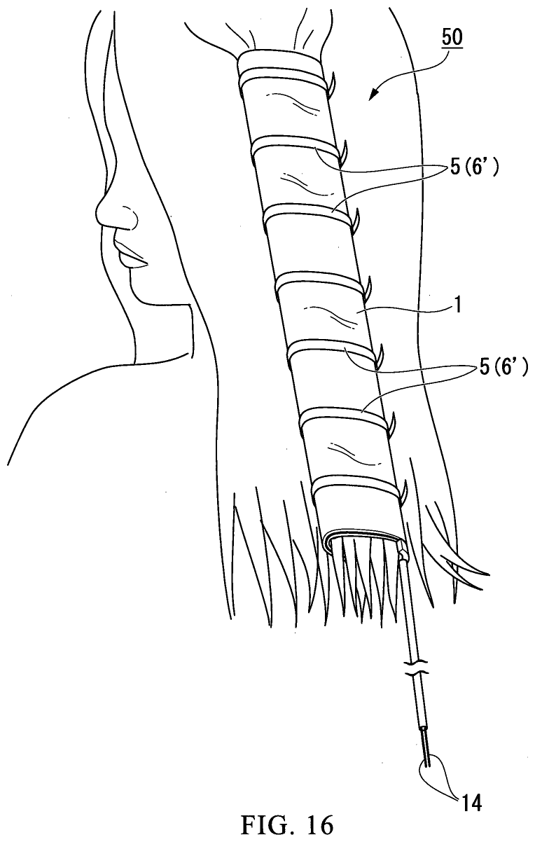

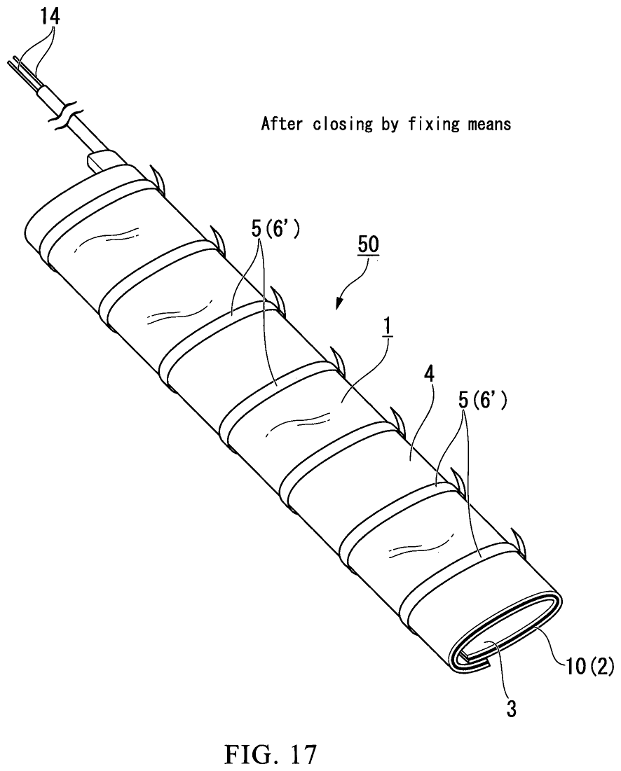

After combing, the portion to which the composition may be applied can be covered with the flexible heating device 1 of the hair shaping system 50 as shown in FIG. 16. In FIG. 16, only the flexible heating device 1 with the fixing means 5 and the electric lead wires 14 are depicted for the hair shaping system 50 and the power source 9 is omitted. FIG. 17 shows the same heating device 1 of the hair shaping system 50 in a use state but without showing the hair which the heating device 1 covers.

The flexible heating device 1 of the hair shaping system 50 may be attached to the portion of the hair by the fixing means 5, that is, seven tape-shaped fasters 6′ such that the portion of the hair is completely covered by the device 1. For the sake of this, the flexible heating device 1 may be attached to the portion of the hair in a rolled shape which tightly surrounds the portion of the hair as shown in FIG. 17. As shown in FIG. 17, the flexible heating device 1 is folded or rolled such that the heat conductive layer 3 is located inside the roll and the device 1 is secured by tightening the tape-shaped fasteners 6′.

In this situation, the portion of the hair to which the component may be applied and which was straightened by combing can be completely covered by the flexible heating device 1. Here, since the flexible heating device 1 can be tightly fixed to the portion of the hair by the tape-shaped fasteners 6′, the portion of the hair to be treated can be set in a closed or occlusive space.

In the next step, electric power can be supplied to the flexible heater 10 of the device 1 from the power source via the electric lead wires 14 to heat the textile heater 10. In this exemplary method, the voltage applied to the flexible heater 10 may be set at 9V (1.32 A) and the time during which the supply of electric power to the textile heater 10 continues may be about 10 minutes. Again, though the most preferable heating time may be 15 to 30 minutes, the time during which the supply of electric power to the textile heater 10 continues may be set about 10 minutes.

In the next step, the power source 9 may be turned off and the hair can be cooled down for 5 minutes.

After that, the flexible heating device 1 can be removed from the hair and the hair may be combed.

After that, a second composition can optionally be applied to the portion of the hair to set the straightened hair.

As explained above, the hair shaping system 50 according to one aspect of the present invention can also be applied to a so-called straight perm or curly hair straightening in which curled hair can be made straight.

The embodiments herein are not limited to the above described preferred embodiments. Various alternatives, modifications and equivalents may be used. Therefore, the above embodiments should not be taken as limiting the scope of the present disclosure, which is defined by the appended claims.

1. A flexible heating device in the form of a sheet, for hair shaping, comprising:
a heating layer comprising at least one flexible heater which can be supplied with electrical power,
a flexible heat conductive layer provided on one surface of the heating layer, and
a flexible heat insulation layer provided on the other surface of the heating layer,
wherein
the device is capable of forming an occlusive or closed space around the hair.

2. The flexible heating device for hair shaping according to claim 1, wherein the flexible heater comprises at least one textile heater.

3. The flexible heating device for hair shaping according to claim 1, wherein the flexible heat conductive layer comprises at least one metal film.

4. The flexible heating device for hair shaping according to claim 3, wherein the metal film comprises aluminum foil.

5. The flexible heating device for hair shaping according to claim 1, wherein the flexible heat insulation layer comprises any one of glass fibers, polyurethane foam, mineral wool, and combinations thereof.

6. The flexible heating device for hair shaping according to claim 1, wherein the device further comprises at least one fixing means for fixing the flexible heating device on the hair.

7. The flexible heating device for hair shaping according to claim 6, wherein the fixing means comprises at least one tape-shaped fastener or at least one elastic ring.

8. A hair shaping system comprising:
one or more flexible heating devices for hair shaping according to claim 1;
a power supply; and
electric lead wires which extend from the flexible heater(s) of the flexible heating device(s) for hair shaping to the power supply.

9. A method of shaping hair, said method comprising the steps of:
a) forming at least one occlusive or closed space around hair to be shaped with a flexible heating device in the form of a sheet comprising a heating layer comprising at least one flexible heater which can be supplied with electrical power, a flexible heat conductive layer provided on one surface of the heating layer, and a flexible heat insulation layer provided on the other surface of the heating layer, and
b) heating the hair with the flexible heating device by applying electric power to the flexible heater.

10. The method of shaping hair according to claim 9, further comprising, before the step a), the step of providing hair with mechanical tension.

11. The method of shaping hair according to claim 9, further comprising, after the step a), the step of fixing the flexible heating device on the hair by at least one fixing means to maintain the occlusive or closed space.

12. The method of shaping hair according to claim 11, wherein the fixing means comprises at least one tape-shaped fastener or at least one elastic ring.

13. The method of shaping hair according to claim 10, wherein the occlusive or closed space comprises a means for providing the hair with mechanical tension.

14. The method of shaping hair according to claim 9, further comprising, before or after the step a), the step of applying at least one composition, including at least one organic or inorganic alkaline agent to the hair.

15. The method of shaping hair according to claim 9, wherein in step b), the heating is performed at a temperature between 30° C. and 200° C.

16. The method of shaping hair according to claim 1, wherein in step b), the heating is performed between 5 and 100 minutes.
